(19) United States
(12) Patent Application Publication
(10) Pub. No.: US 2005/0265022 A1
(43) Pub. Date: Dec. 1, 2005

(54) Backlight module

(76) Inventor: Heng-Sheng Kuo, Taipei (TW)

Correspondence Address: HENG-SHENG KUO, P.O. BOX 26-757, TAIPEI, 106, TW

(21) Appl. No.: 10/857,383

(22) Filed: May 28, 2004

(51) Int. Cl. F21V 7/04

(52) U.S. Cl. 362/227; 362/26

(57) ABSTRACT

A backlight module has a plastic frame and a rigid frame engaged mutually, of which the plastic frame is arranged at its top with a stop sheet protruding inward along the inner perimeter. A light-guide plate and a light-emitting element are arranged between the rigid and plastic frames, a group of a optical elements is arranged on the stop sheet, and the module is further coupled with a glass substrate positioned on the group of optical elements. The products are thus easily and smoothly assembled, the group of optical elements are conveniently checked and the rigid and plastic frames are easily disassembled from each other.

### BACKGROUND OF THE INVENTION

1. Field of the Invention

This invention relates to a backlight module, and particularly to a backlight module that is easy to assemble, test and disassemble.

2. Description of the Prior Art

Generally, a backlight module refers to a device element capable of providing light source from the back of a product, which has being widely used in various products relative to information, communication and consumer goods, such as liquid crystal displays (LCD), film scanners, slide projectors and so on. The backlight module mainly includesinlcudes an incident light source, a light-guide plate, a diffusion sheet, a prism sheet and a brightness enhancement film (BEF). Put simply, its principle is that a self-luminous light from a light source, for example, a cold cathode fluorescent lamp (CCFL) and a light-emitting diode (LED), is conducted in by a light-guide plate to produce an even surface light source. Meanwhile, to keep the products competitive in future markets, the backlight module needs to take several product evolution directions into account: lighter weight, miniaturization, lower power consumption, higher brightness and lower cost.

Reference is made to FIG. 1, which is an assembly diagram of a conventional backlight module 1a. The module 1a includes a plastic frame 10a and a rigid frame 11a, which are engaged with each other and form a receiving space therebetween, and further a light-guide plate 12a, light-emitting element 13a, a reflective sheet 14a, at least one diffusion sheet 15a and at least one prism sheet 16a, all of which are received within the receiving space. Finally the module is coupled with a glass substrate 2a. The plastic frame 10a is provided with a perimetric stop sheet 101a that is arranged to protrude inward along the inner perimeter at the top side of the frame 10a. During assembly of the module, the plastic frame 10a is upside down with respect to FIG. 1, while the perimetric stop sheet 101a is located beneath the plastic frame 10a. According to the design requirement, the diffusion sheet 15a and the prism sheet 16a are placed in order on the perimetric stop sheet 101a. After the light-guide plate 12a and the light-emitting element 13a are mounted, the reflective sheet 14a is laid on the light-guide plate 12a. The rigid frame 11a and the plastic frame 10a are is then engaged for the purpose of securing the light-guide plate 12a and the light-emitting element 13a. At this time, the semi-finished product is roughly assembled. The semi-finished product is then put upside down, such that the perimetric stop sheet 101a is located above the plastic frame 10a. The glass substrate 2a is mounted on the perimetric stop sheet 101a, allowing the glass substrate 2a in connection with the diffusion sheet 15a, the prism sheet 16a, the light-guide plate 12a, the light-emitting element 13a and the reflective sheet 14a to be arranged opposite the perimetric stop sheet 101a.

However, during assembling of the conventional backlight module 1a, a step of turning over the plastic frame 10a is required, and it is thus obvious that the assembly process is not smooth. Furthermore, the rigid frame 11a and the plastic frame 10a are arranged with a mutual securing engagement structure. After the rigid frame 11a is engaged and secured with the plastic frame 10a, it is to disassemble, which is a disadvantageous to the improvement of production efficiency. If there is any need for maintenance and repair or the the diffusion sheet 15a or the prism sheet 16a needs to be replaced, the rework process is cumbersome and the products are prone to damage; the structure is thus disadvantageous to the improvement of product yield. The above-mentioned product damage includes scoring and scratches on the diffusion sheet 15a, the prism sheet 16a, the light-guide plate 12a and the reflective sheet 14a, which adversly affect the overall brilliancy, thus reducing the value of the products. Moreover, depending on different design requirements, the number and the assembling sequence of the diffusion sheets 15a and the prism sheets 16a to be assembled may be not the same. In the event that a polarizing sheet, a intensifier sheet and other elements are added for purpose of adaptation of further optical characteristic, and it is desired to perform a test process to verify the elements are assembled in right sequence and registered properly, similar problems occur during the test process. Dissassembly of the engaged rigid frame 11a and plastic frame 10a is difficult, and the products are potentially damaged during disassembly and reassembly of the elements. Additionally, in the assembled structure of the conventional backlight module 1a, the stop sheet 101a is arranged on the optical films; thus the upward and even light output obtained from the effect of those optical films is subject to reduced light output area due to blocking by the stop sheet 101a. The conventional backlight module 1a is obviously unable to be made more cheaply.

Accordingly, this invention is provided to remove the above disadvantages with a reasonable design.

### SUMMARY OF THE INVENTION

The main object of the invention is to provide a backlight module, which can reduce turnover steps, allowing the products to be easily and smoothly assembled and improves production efficiency to further reduce production costs.

An another object of the invention is to provide a backlight module, which allows convenient checking that the module is properly assembled. The the module is additionally easily repaired, further improving production efficiency and reducing production costs.

Yet another object of the invention is to provide a backlight module, which can avoid product damage during disassembly of the engaged rigid and plastic frames and eliminate defects to reduce further scrap possibility and production costs.

Yet another object of the invention is to provide a backlight module, which can increase a light output area, to achieve efficient utilization of the backlight module, thus further reducing production costs.

In order to achieve the above object, the present invention provides a backlight module, consisting of mutually engaged rigid and plastic frames, of which the plastic frame is arranged at its top with a stop sheet protruding inward along the inner perimeter, a light-guide plate and a light-emitting element arranged between the rigid and plastic frames, and a group of optical elements arranged on the stop sheet. The module is further coupled with a glass substrate positioned on the group of optical elements, thereby allowing the products to be easily and smoothly assembled. The group of optical elements can be conveniently checked and the rigid and plastic frames are easily disassembled from each other.

The features and technical contents of the present invention will become apparent from the detailed description of the present invention with reference to the accompanying drawings; the detailed description and drawings are intended to be illustrative and not restrictive.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a diagrammatic view illustrating a conventional backlight module;

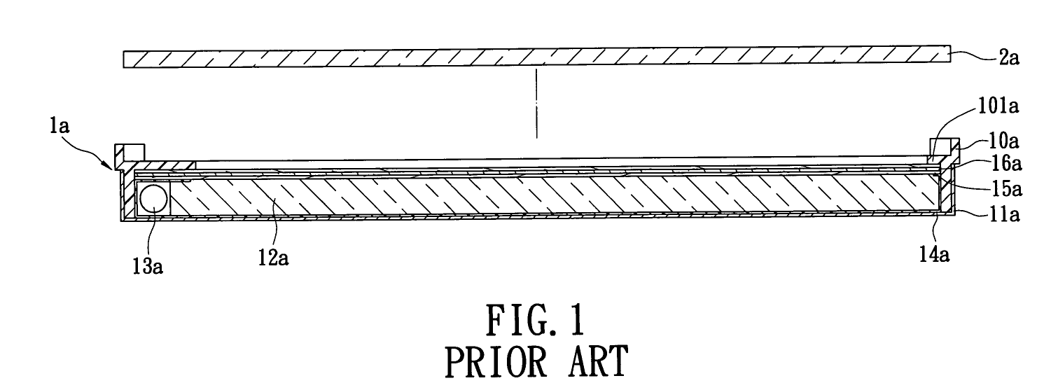

FIG. 2 is a diagrammatic view illustrating an embodiment of the backlight module according to this invention; and

FIG. 3 is a diagrammatic view illustrating an another embodiment of the backlight module according to this invention.

### DETAILED DESCRIPTION OF THE EMBODIMENTS

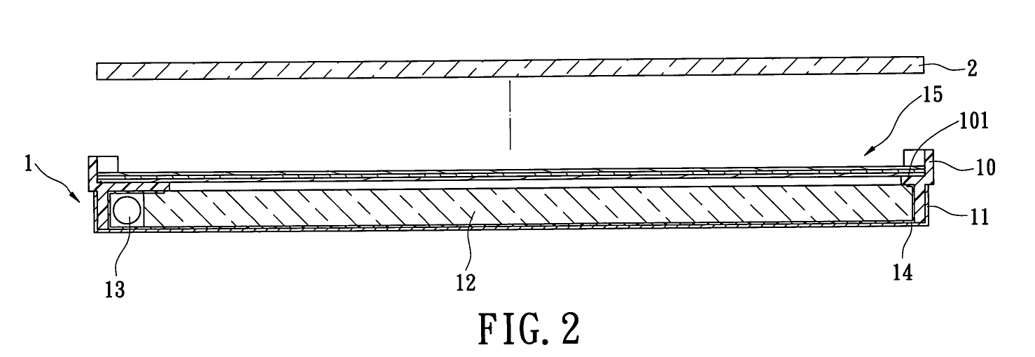

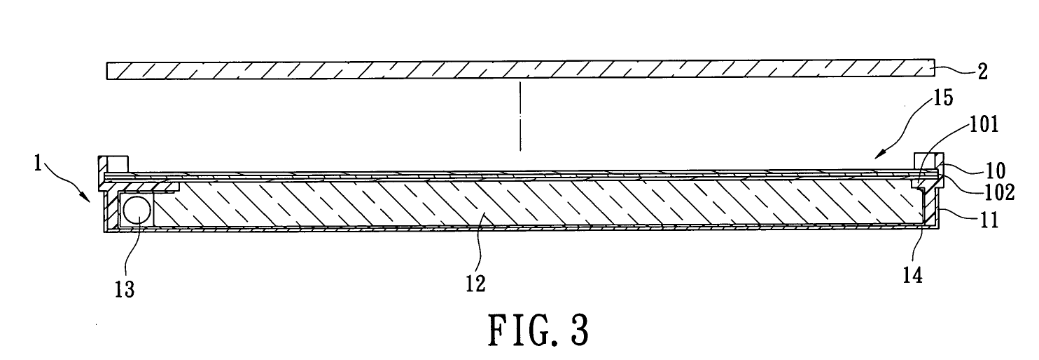

FIG. 2 illustrates a backlight module 1 according to this invention, consisting of mutually engaged plastic frame 10 and the rigid frame 11, in which the plastic frame 10 is arranged at its top with a stop sheet 101 protruding inward along the inner perimeter, a light-guide plate 12 and a light-emitting element 13 arranged between the rigid and plastic frames 11 and 10, and a group of optical elements 15 arranged on the stop sheet 101. The module is coupled with a glass substrate 2 on the group of optical elements 15. The plastic frame 10 and the rigid frame 11 are made of plastic and metal (particularly iron), respectively. The stop sheet 101 together with the rigid frame 11 form a receiving space, so as to be used to sandwich securely the light-guide plate 12 and the light-emitting element 13. The plastic frame 10 can continue to use the conventional design with a stop sheet 101; alternatively, the plastic frame 10 is provided such that the size and height of the stop sheet 101 can be adjusted, for further facilitating disposal of the light-guide plate 12. A reflective element 14 is arranged between the light-guide plate 12 and the rigid frame 11, which may be disposed in the form of a reflective sheet or a reflective film beneath the light-guide plate 12; alternatively, the reflective element 14 with reflective capability can be formed by directly plating a reflective layer on the lower surface of the light-guide plate 12. In particular, due to the existence of the stop sheet 101, a small gap is formed between the light-guide 12 and the group of optical elements 15. A thin additional layer is arranged as an extension of the light-guide plate 12 (with reference to FIG. 3), so as to fill in the gap and be joined with the group of optical elements 15. The plastic frame 10 is further arranged with a caulking groove 102 above the stop sheet 101 (with reference to FIG. 3), so as to accommodate various sizes of the group of optical elements 15 to provide a further function of engaging with the group of optical elements 15. The light-emitting element 13 may be a cold cathode fluorescent lamp (CCFL) or a light-emitting diode (LED), which may be strip-shaped or L-shaped, and be arranged aside or around the light-guide plate 12, in order to meet the requirement of nondirectional light output. The group of optical elements 15 comprises a diffusion sheet, a prism sheet and so on. Depending on various design requirements, the number and sequence of these diffusion sheets and prism sheets may be configured variably. In order to achieve special optical effects, the group of optical elements 15 may further comprise a polarizing sheet, a color filter (CF), brightness enhancement film (BEF), anti-glare film (AG film), anti-reflective film (AR film) and so on, according to specific design requirements.

The backlight module according to the invention is assembled in the following steps. The reflective element 14, the light-guide 12 and the light-emitting element 13 are directly received into the receiving space of the rigid frame 11. The plastic frame 10 is the inserted to be jacketed and engaged with the rigid frame 11, so as to sandwich the light-guide plate 12 and light-emitting element 13 in between. The need of a turnover step for the plastic frame 10 is eliminated, thereby facilitating the easy and smooth assembly of the module, and thus further speeding production flow and improving production efficiency. Additionally, according a specific design requirement, the group of optical elements 15 are arranged above the stop sheet 101, such that the group of optical elements 15 and the light-guide plate 12 form a relationship in which they are positioned at opposite sides of the stop sheet 101. In particular, a side light source emitted from the light-emitting element 13 is converted into a surface light source through the light-guide plate 12. After the light source passes through the stop sheet 101, benefiting from the optical effect of the diffusion sheet or the prism sheet in the group of optical elements 15, the projection of the surface light source is not affected by the limit of the stop sheet 101, thereby increasing the area of the light output and achieving the efficient utilization of the backlight module 1.

During situation such as, for example, examination, maintenance or material replacement during the production process, the backlight module 1 according to this invention can easily be examined and the constitution and configuration of the group of optical elements 15 changed and replaced, without dissassembling the plastic frame 10 from the rigid frame 11, thereby improving assembling the quality of the backlight module 1 and the entire production efficiency. In addition, without dissassembling the mutually engaged rigid frame 11 and plastic frame 10, the risk of unnecessary damage to the products, such as scratches resulting in uneven overall brilliance can be avoided, thereby reducing the manufacturing cost.

With respect to the backlight module industry, material costs are a significant portion of the total cost of a backlight module, and some key materials are mainly sourced from only a few Japanese and US manufacturers; the profit margins of backlight module manufacturers therefore rests on assembling charge and other expenses. From the view point of the manufacturing process, a backlight module can be considered to be a labor-intensive assembly industry with high management requirements. Therefore, the backlight module 1 according to the invention features advantages of being easy to assemble and examine and being convenient to maintaine. This not only improves the smoothness of the production flow, but also effectively reduces examination and scrap costs; furthermore the efficient utilization of the light output area is improved. The backlight module 1 according to this invention has a great advantage in keeping competitive in the era of profit squeezing. In conclusion, the desired objects and functions are achieved in this invention; while the techniques and means have been disclosed above merely as one of the preferred embodiments of this invention. It is intended that the appended claims cover all such modifications and variations made to these embodiments as fall within the spirit and scope of this present invention.

1. A backlight module, comprising:
a plastic frame and a rigid frame 11 mutually engaged, wherein the plastic frame is arranged on a top thereof with a stop sheet protruding inward along an inner perimeter thereof;
a light-guide plate and a light-emitting element received between the rigid and plastic frames; and
a group of optical elements arranged on the stop sheet.

2. The backlight module according to claim 1, wherein the plastic frame includes a caulking groove further arranged above the stop sheet thereof, and the caulking groove is engaged with and clamps the group of optical elements.

3. The backlight module according to claim 1, further including a reflective element sandwiched between the light-guide plate and the rigid frame.

4. The backlight module according to claim 1, wherein the light-guide plate has a reflective layer provided at a bottom thereof.

5. The backlight module according to claim 1, wherein the light-guide plate has a thin layer extending upward therefrom to join with the group of optical elements.

6. The backlight module according to claim 1, wherein the group of optical elements includes a diffusion sheet.

7. The backlight module according to claim 1, wherein the group of optical elements includes a prism sheet.
